(19) United States
(12) Patent Application Publication
(10) Pub. No.: US 2025/0234393 A1
(43) Pub. Date: Jul. 17, 2025

(54) METHODS, APPARATUSES AND COMPUTER PROGRAM

(71) Applicant: Nokia Technologies Oy, Espoo (FI)

(72) Inventors: Halit Murat GÜRSU, Munich (DE); Malgorzata TOMALA, Wroclaw (PL); Umur KARABULUT, Munich (DE); Anna PANTELIDOU, Massy (FR); Ömer BULAKCI, Munich (DE)

(21) Appl. No.: 18/551,086

(22) PCT Filed: Mar. 31, 2021
(86) PCT No.: PCT/EP2021/058489

§ 371 Date: Sep. 18, 2023

(51) Int. Cl. H04W 74/0833; H04W 8/22; H04W 72/121

(52) U.S. Cl. CPC H04W 74/0841; H04W 8/22; H04W 72/121

(57) ABSTRACT

An apparatus comprises means for: causing a communication device to make a first random access attempt using random access configuration information for a group associated with the communications device; determining a failure of the first random access attempt; and causing information related to the failure to be transmitted to the base station, said information comprising group related information.

### FIELD

The present application relates to a method, apparatus, and computer program and in particular but not exclusively a method, apparatus, and computer program relating to random access failure associated with a group.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standards are the so-called 5G standards.

Slicing is a concept which has been introduced in 5G. An operator transforms its network into a set of logical networks on top of a shared infrastructure. Each logical network (known as a slice) of the set of logical networks may be designed to serve at least one defined purpose and comprises the required network resources, configured and connected end-to-end. The slices are assigned to a subscriber for the desired services

### SUMMARY

According to an aspect, there is provided apparatus comprising means for: causing a communication device to make a first random access attempt using random access configuration information for a group associated with the communications device; determining a failure of the first random access attempt; and causing information related to the failure to be transmitted to the base station, said information comprising group related information.

The group related information may comprise one or more of slice information; a type of the communication device; one or more capabilities of the device; quality of service priority; one or more bandwidth parts; and information identifying the group.

The means may be for determining a time associated with the first random access attempt.

The means may be for causing the information related to the failure which is transmitted to the base station to include information about the time associated with the first random access attempt.

The means may be for causing the information to be transmitted to the base station after a random access attempt has succeeded.

The means may be for causing the communication device to make one or more further random access attempts using random access configuration information for a respective group associated with the communications device, determining a failure of one or more further random access attempts, and causing information associated with the failure of the one or more further failed random access attempts to be transmitted to the base station.

One or more of the further random access attempts may relate to a different slice to that slice associated with the first random access attempt.

The means may be for causing the information for the first random access attempt to be transmitted to the base station with the information associated with the failure of the one or more further failed random access attempts.

The means may be for selecting a random access occasion based on the random access configuration information for the group associated with a communications device and causing the first random access message to be transmitted from the communications device to the base station in the selected random access occasion.

The means may be for receiving information about the group, the information comprising the random access configuration and a definition of the group.

The definition of the group may specify one or more of: one or more slices; one or more types of communications device; one or more device capabilities; one or more quality of service priorities; and one or more bandwidth parts.

The information related to the failure sent to the base station may comprise information indication a random access preamble used in the first random access attempt.

The apparatus may be provided in a communication device or may be a communication device.

According to another aspect, there is provided an apparatus, the apparatus comprising at least one processor and at least one memory including a computer program code, the at least one memory and computer program code configured to, with the at least one processor, cause the apparatus at least to: cause a communication device to make a first random access attempt using random access configuration information for a group associated with the communications device; determine a failure of the first random access attempt; and cause information related to the failure to be transmitted to the base station, said information comprising group related information.

The group related information may comprise one or more of slice information; a type of the communication device; one or more capabilities of the device; quality of service priority; one or more bandwidth parts; and information identifying the group.

The at least one memory and at least one processor may be configured to cause the apparatus to determine a time associated with the first random access attempt.

The at least one memory and at least one processor may be configured to cause the apparatus to cause the information related to the failure which is transmitted to the base station to include information about the time associated with the first random access attempt.

The at least one memory and at least one processor may be configured to cause the apparatus to cause the information to be transmitted to the base station after a random access attempt has succeeded.

The at least one memory and at least one processor may be configured to cause the apparatus to cause the communication device to make one or more further random access attempts using random access configuration information for a respective group associated with the communications device, determining a failure of one or more further random access attempts, and causing information associated with the failure of the one or more further failed random access attempts to be transmitted to the base station.

One or more of the further random access attempts may relate to a different slice to that slice associated with the first random access attempt.

The at least one memory and at least one processor may be configured to cause the apparatus to cause the information for the first random access attempt to be transmitted to the base station with the information associated with the failure of the one or more further failed random access attempts.

The at least one memory and at least one processor may be configured to cause the apparatus to select a random access occasion based on the random access configuration information for the group associated with a communications device and causing the first random access message to be transmitted from the communications device to the base station in the selected random access occasion.

The at least one memory and at least one processor may be configured to cause the apparatus to receive information about the group, the information comprising the random access configuration and a definition of the group.

The definition of the group may specify one or more of: one or more slices; one or more types of communications device; one or more device capabilities; one or more quality of service priorities; and one or more bandwidth parts.

The information related to the failure sent to the base station may comprise information indication a random access preamble used in the first random access attempt.

The apparatus may be provided in a communication device or may be a communication device.

According to another aspect, there is provided a method comprising: causing a communication device to make a first random access attempt using random access configuration information for a group associated with the communications device; determining a failure of the first random access attempt; and causing information related to the failure to be transmitted to the base station, said information comprising group related information.

The group related information may comprise one or more of slice information; a type of the communication device; one or more capabilities of the device; quality of service priority; one or more bandwidth parts; and information identifying the group.

The method may comprise determining a time associated with the first random access attempt.

The method may comprise causing the information related to the failure which is transmitted to the base station to include information about the time associated with the first random access attempt.

The method may comprise causing the information to be transmitted to the base station after a random access attempt has succeeded.

The method may comprise causing the communication device to make one or more further random access attempts using random access configuration information for a respective group associated with the communications device, determining a failure of one or more further random access attempts, and causing information associated with the failure of the one or more further failed random access attempts to be transmitted to the base station.

One or more of the further random access attempts may relate to a different slice to that slice associated with the first random access attempt.

The method may comprise causing the information for the first random access attempt to be transmitted to the base station with the information associated with the failure of the one or more further failed random access attempts.

The method may comprise selecting a random access occasion based on the random access configuration information for the group associated with a communications device and causing the first random access message to be transmitted from the communications device to the base station in the selected random access occasion.

The method may comprise receiving information about the group, the information comprising the random access configuration and a definition of the group.

The definition of the group may specify one or more of: one or more slices; one or more types of communications device; one or more device capabilities; one or more quality of service priorities; and one or more bandwidth parts.

The information related to the failure sent to the base station may comprise information indication a random access preamble used in the first random access attempt.

The method may be performed by an apparatus. The apparatus may be provided in a communication device or may be a communication device.

According to another aspect, there is an apparatus comprising means for: receiving information from a plurality of communication devices, the information from a respective communication device indicating group related information associated with a failed random access attempt using random access configuration information for a group associated with the respective communications device; and based on the received information, sending a report to a network entity which defines the one or more groups.

The group related information may comprise one or more of slice information; a type of the communication device; one or more capabilities of the device; quality of service priority; one or more bandwidth parts; and information identifying the group.

The means may be for determining, based on the received information, collision information, said report comprising collision information.

The collision information may relate to one or more of: collisions experienced one or more of at least two different types of communication device, at least two different communication devices with different capabilities; different slices; and different bandwidth parts.

The report may comprise information for requesting the separation into different groups of one or more of: two different communication device types, two different slices; two different communication device capabilities; and two different bandwidth parts.

The report may comprise information for one or more group modifications and/or identifying one or more problems.

The means may be for providing information about one or more of the groups to communication devices, the information for a respective group comprising the random access configuration for the respective group and a definition of the respective group.

The apparatus may be provided in a base station or other access node or may be a base station or other access node.

According to another aspect, there is provided an apparatus, the apparatus comprising at least one processor and at least one memory including a computer program code, the at least one memory and computer program code configured to, with the at least one processor, cause the apparatus at least to: receive information from a plurality of communication devices, the information from a respective communication device indicating group related information associated with a failed random access attempt using random access configuration information for a group associated with the respective communications device; and based on the received information, send a report to a network entity which defines the one or more groups.

The group related information may comprise one or more of slice information; a type of the communication device; one or more capabilities of the device; quality of service priority; one or more bandwidth parts; and information identifying the group.

The at least one memory and at least one processor may be configured to cause the apparatus to determine, based on the received information, collision information, said report comprising collision information.

The collision information may relate to one or more of: collisions experienced one or more of at least two different types of communication device, at least two different communication devices with different capabilities; different slices; and different bandwidth parts.

The report may comprise information for requesting the separation into different groups of one or more of: two different communication device types, two different slices; two different communication device capabilities; and two different bandwidth parts.

The report may comprise information for one or more group modifications and/or identifying one or more problems.

The at least one memory and at least one processor may be configured to cause the apparatus to provide information about one or more of the groups to communication devices, the information for a respective group comprising the random access configuration for the respective group and a definition of the respective group.

The apparatus may be provided in a base station or other access node or may be a base station or other access node.

According to another aspect, there is a method comprising: receiving information from a plurality of communication devices, the information from a respective communication device indicating group related information associated with a failed random access attempt using random access configuration information for a group associated with the respective communications device; and based on the received information, sending a report to a network entity which defines the one or more groups.

The group related information may comprise one or more of slice information; a type of the communication device; one or more capabilities of the device; quality of service priority; one or more bandwidth parts; and information identifying the group.

The method may comprise determining, based on the received information, collision information, said report comprising collision information.

The collision information may relate to one or more of: collisions experienced one or more of at least two different types of communication device, at least two different communication devices with different capabilities; different slices; and different bandwidth parts.

The report may comprise information for requesting the separation into different groups of one or more of: two different communication device types, two different slices; two different communication device capabilities; and two different bandwidth parts.

The report may comprise information for one or more group modifications and/or identifying one or more problems.

The method may comprise providing information about one or more of the groups to communication devices, the information for a respective group comprising the random access configuration for the respective group and a definition of the respective group.

The method may be performed by an apparatus. The apparatus may be provided in a base station or other access node or may be a base station or other access node.

According to another aspect, there is provided a network entity comprising means for: defining one or more groups; causing information about one or of the groups to be provided to one or more communication devices, said information for a respective group comprising random access configuration information and a definition of the respective group; receiving a report from one or more base stations, the report relating to random access attempt failures associated with communication devices, a respective failed random access attempt using random access configuration for a respective group associated with a respective communication device; and in response to the report, updating one or more groups.

The network entity may be an access management function.

According to another aspect, there is provided a network entity comprising at least one processor and at least one memory including a computer program code, the at least one memory and computer program code configured to, with the at least one processor, cause the network entity at least to: define one or more groups; cause information about one or of the groups to be provided to one or more communication devices, said information for a respective group comprising random access configuration information and a definition of the respective group; receive a report from one or more base stations, the report relating to random access attempt failures associated with communication devices, a respective failed random access attempt using random access configuration for a respective group associated with a respective communication device; and in response to the report, update one or more groups.

The network entity may be an access management function.

According to another aspect, there is a method comprising: defining one or more groups in a network entity; causing information about one or of the groups to be provided to one or more communication devices, said information for a respective group comprising random access configuration information and a definition of the respective group; receiving a report from one or more base stations, the report relating to random access attempt failures associated with communication devices, a respective failed random access attempt using random access configuration for a respective group associated with a respective communication device; and in response to the report, updating one or more groups.

The method may be performed by a network entity. The network entity may be an access management function.

According to an aspect, there is provided a computer readable medium comprising program instructions for causing an apparatus to perform at least the method according to any of the preceding aspects.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5G system;

FIG. 2 shows a schematic diagram of an example communication device;

FIG. 3 shows a schematic diagram of an example apparatus;

FIG. 4 shows the format of a S-NSSAI (Single-Network Slice Selection Assistance Information);

FIG. 5 shows a message signalling between a communication device, a base station and an access and mobility management function;

FIG. 6 schematically shows an example of use of a random access log timer in a first scenario;

FIG. 7 schematically shows an example of when the communication device provides a random access resource selection report;

FIG. 8 schematically shows another example of when the communication device provides a random access resource selection report;

FIG. 9 shows a flowchart of a method performed by an apparatus of a communication device according to an example embodiment;

FIG. 10 shows a flowchart of a method performed by an apparatus of a base station according to an example embodiment; and

FIG. 11 shows a flowchart of a method performed by a network entity according to an example embodiment.

### DETAILED DESCRIPTION

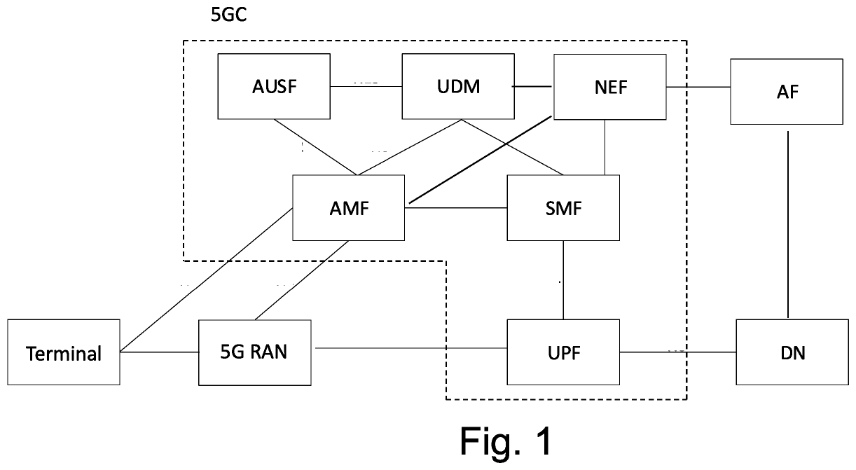

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application functions (AF) and one or more data networks (DN).

The 5G-RAN may comprise one or more base stations. In 5G the base station may be referred to as a gNodeB (gNB). The RAN may comprise one or more gNodeB (gNB) (or base station) distributed unit functions connected to one or more gNodeB (gNB) (or base station) centralized unit functions.

The 5GC may comprise the following entities: one or more access management functions (AMF), one or more session management functions (SMF), an authentication server function (AUSF), a unified data management (UDM), one or more user plane functions (UPF), and/or a network exposure function (NEF).

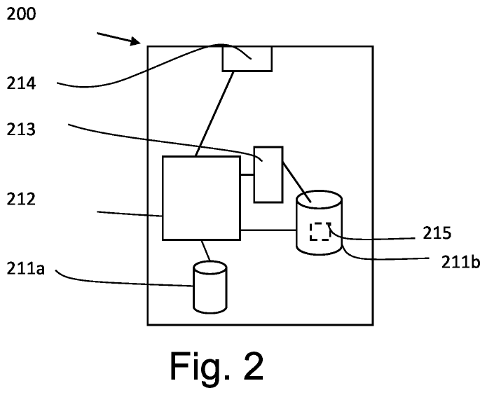

FIG. 2 illustrates an example of an apparatus 200. Ths apparatus may be provided for example in a communications device, or a base station (e.g. gNB) or in an AMF. The apparatus may comprise at least one memory. By way of example only the at least one memory may comprise random access memory (RAM) 211a and at least on read only memory (ROM) 211b. Apparatus used by other embodiments may comprise different memory.

The apparatus may comprise at least one processor 212, 213. In this example apparatus, two processors are show.

The apparatus may comprise an input/output interface 214.

The at least one processor may be coupled to the at least one memory. The at least one processor may be configured to execute an appropriate software code 215. The software code 215 may for example allow the method of some embodiments to be performed.

The software code 215 may be stored in the at least one memory, for example ROM 211b.

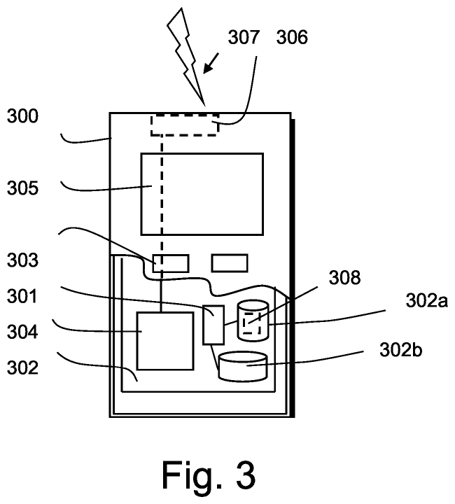

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 311a and the ROM 311b. The at least one processor 301 may be configured to execute an appropriate software code 308. The software code 308 may for example allow to perform one or more of the present aspects. The software code 308 may be stored in the ROM 311b.

The processor, storage and other relevant control apparatus can be provided on an appropriate circuit board and/or in chipsets. This feature is denoted by reference 304.

The device may optionally have a user interface such as keypad 305, touch sensitive screen or pad, combinations thereof or the like.

Optionally one or more of a display, a speaker and a microphone may be provided depending on the type of the device.

In the following examples, the communications device is referred to as a UE. However, it should be appreciated that the communication device can any suitable communications device, some examples of which have already been mentioned.

Network slicing is provided in 5G. Network slicing supports different services using the same underlying mobile network infrastructure. One example of network slicing is described in 3GPP TS 38.300.

Network slices can differ in their service requirements. For example the service requirement may be an ultra-reliable low latency communication (URLLC) service requirement or an enhanced mobile broadband (eMBB) service requirement. Network slices can differ in the tenant that provides those services.

A network slice is uniquely identified via S-NSSAI (Single-Network Slice Selection Assistance Information). A UE may be simultaneously connected and served by a given maximum number of S-NSSAIs. In 3GPP TS 38.300, for example, the maximum is eight. For some embodiments, the maximum may be eight. Other embodiments may have a different maximum which may be more or less than eight.

Each cell may support tens or even hundreds of S-NSSAIs. For example, in 3GPP TS 38.300, a tracking area can have a support up to 1024 network slices. For some embodiments, the maximum number of supported slices may be 1024. Other embodiments may have a different maximum which may be more or less than 1024.

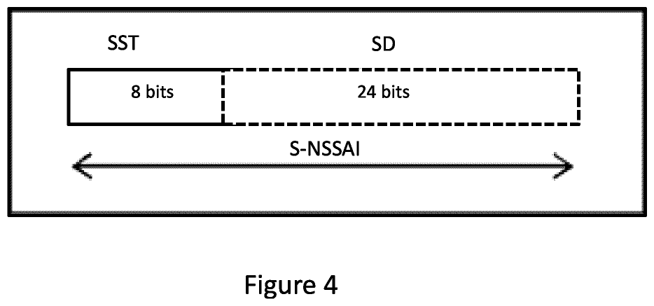

Reference is made to FIG. 4 which shows the format of a S-NSSAI. The S-NSSAI may comprise a slice service type (SST) and Slice Differentiator (SD) field. The total length of the S-NSSAI may be 32 bits with 8 bits for the SST and 24 bits for the SD field. Alternatively the S-NSSAI may include only the SST field part. In this latter case the length of the length of S-NSSAI is 8 bits only. The total length of the field and/or the length of individual fields may be different in other embodiments.

The SST field may have standardized. Values 0 to 127 belong to the standardized SST range. For instance, SST value of 1 may indicate that the slice is suitable for handling of 5G eMBB, 2 for handling of URLLC, etc.

The SST may also comprise non-standardized values

SD may be operator-defined only.

In order to maintain flexible access to radio resources from different cells a shared channel is used. That shared channel may be a physical random access channel (PRACH). Communication devices access the shared channel to make use of resources for various different reasons.

Some examples of contention-based and contention-free random access (RA) use is as follows:
Handover-dedicated, i.e., can be contention free RA (CFRA)
Initial access
Beam failure recovery-dedicated, i.e., can be contention free RA (CFRA)
Scheduling Request
Not enough PUCCH (physical uplink shared channel) resources
RRC state transition
TAU (tracking area update), RNAU (RAN-based notification area update).

As communication devices randomly select one of the random access resources, while using PRACH resources, the communication devices may be interfering with each other.

One issue is that some enterprise/industrial scenarios (and/or other scenarios) have a requirement for access resource isolation. This may be in order to provide guaranteed resources for sensitive slices e.g., in the case of random access (RA) resources.

Another issue is that communication devices may not be differentiated on the network side. This may be the case for example in the initial access. However some slices may need to be prioritized during the initial access e.g., in case of RA procedure. Therefore, the initial access resources, e.g., RA resources in case of a 5G slicing scenario, are proposed to be categorized for different groups of slices.

A random access (RA) procedure comprises a sequence of messages between the UE and gNB (or other access point) in order to acquire, for the UE, uplink synchronization and obtain resources (e.g. for MSGA or MSG1 transmission). The UE can determine how it can access the cell, upon acquiring common RACH configuration (or later upon reception of dedicated RACH configuration). The RA procedure can be used for transmitting data as in 2-step RACH.

One example of a four step RA procedure is as follows: a UE sends a PRACH preamble to a base station/network (Msg1). The base station responds to the UE with a random access response (Msg 2). The UE transmits a connection request to the base station (Msg 3). In response the base station sends a message, Msg4. Optionally the gNB may provide a downlink payload.

One example of a two-step RA procedure is as follows: the UE sends a PRACH preamble to a base station (Msg A). The base station responds to the UE with a random access response (Msg B).

Currently, all communication devices supporting and requesting a certain slice use the same RACH configurations for different slices. This is because currently the random access procedure and gNB configurations for this are slice information agnostic.

The communication devices or UEs accessing the same RACH can differ in one or more of the following respects:
UE capabilities:
   UE type, RedCap (reduced capability) or legacy device (for example a NR (new radio) device).
   UE mobility type, (for example low, medium, or high).
   UE BWP (bandwidth parts).
   UE slice
UE attempted traffic:
   UE DRB/SRB (dedicated radio bearer/signalling radio bearer) QoS (quality of service) priority, for example a UE with a high priority DRB or a UE with a low priority DRB.
   UE emergency call, or other prioritized type of access.
   UE services for the UE-associated slices.

The additional requirement to support IoT (internet of things) and different slice supporting devices may cause issues in relation to performance expectations from RACH resources. This may be an issue where there are differences in device capabilities and/or attempted traffic.

Consider the following scenario. A UE has to use random access for initial access to the cell. While using initial access, different UEs may interfere with each other. If the different UEs are coming from different slices, it should be avoided that they affect each other This can done with the separation of random access resources. This may be achieved with RACH resource isolation and/or slice access prioritization.

As discussed, a UE can connect up to a maximum number (for example 8) slices simultaneously. A BS may support many more. For example a tracking area can support up to 1024 slices (or other maximum number). It may be problematic for a base station to provide different random access resources to all slices. However, some of the slices may be grouped to use the same random access resource. This may be done using a resource pool. This grouping may be done based on, e.g., the SLAs (service level agreements) of slices, such as the service availability requirements.

Given the random nature of the RACH, different UEs sharing the same RACH may cause problems with each other.

Consider a scenario where random access resources are common in a cell. Before the procedure can be initiated, the UE would needs to know the available set of resources for the attempted cell by RRC signalling (for example available preambles, PRACH configuration). The signalling enables control and steering of RACH resources in a generic, i.e. not specific for any type of device manner. However, a RedCap UE and a legacy UE from different slice may will cause problems to each other. The network will be unaware of this issue.

Consider a scenario where a RA-report is used such that UEs log their status and provide information related to their random access. The effect of the UEs coming from different slices cannot be extracted by the network using the RA-report. Current RA-reports indicate the number of RA attempts for a UE and observed contention. With this information it can be seen that a UE had contention. The current report does not provide the random access preamble and time. The current report only contains successful attempts. The current report does not allow a determination that a UE from slice A has caused problems for a UE from slice B.

One issue which has been identified is that the network cannot be sure if two UEs from the same slice are affecting each other or two UEs from different slices are affecting each other. The network cannot do a grouping of slices and confirm that they do not affect each other. As will be described later, some embodiments aim to address or at least mitigate this issue.

The current RA-report is only generated if RA is finally successful. As the UE needs to connect before sending the report of the RA attempt, it will generate a successful RA attempt.

Only the most recent RA attempts are kept. Another issues which has been identified is that if two UEs from two slices caused problems to each and restart the RACH process, no RA-report is generated.

Some embodiments provide a method to organize groups with different UEs for random access resource use. This aims to minimize the collision between different UEs. The different UEs may be from different slices, be of different types, and/or BWPs.

The group can be for a UE type, different slices, BWPs, and/or flow priorities. The group may be dynamically allocated based on feedback information from the UEs on random access performance. Some embodiments thus allow the groups to be updated based on feedback from one or more UEs.

A certain type of UEs may be grouped to use the same RACH configuration. A timer for the UEs in the same group is provided. The UEs may be configured to report their slice IDs (i.e., S-NSSAIs and/or any index mapping onto S-NSSAIs) that they have used within a RA attempt. Using this information, the network may determine which UE types have caused problems to each other. The network may re-organize the group of slices using the same RA resource.

Some embodiments provide a method where the AMF defines one or more groups. Generally the AMF will define more than one group. The AMF defines a group which is referred to as group A. This definition will include one or more of UE type, UE capability, different slices, BWPs, flow priorities, etc. For example, if a UE is configured for a particular slice, then the group associated with that slice will need to be used. If the UE is a particular type of UE, the UE will need to use the group associated with that UE type.

The AMF signals the group A definition to the base station. The base station signals the group A definition to the UEs. In some embodiments, only relevant groups are configured by the UEs. For example, if a UE does not subscribe to slice 5 and group 4 is associated with slice 5, the UE will not be configured for group 4. The base station signals the specific RACH configuration for group A

The UE receives the UE group-specific RACH configuration. The UE identifies its own type once attempting initial access (Random Access procedure). In other words, the UE will determine for the particular slice which group it belongs and hence the specific RACH configuration which applies.

The UE initiates the timer “T_{RAL}” after its first random access attempt. The timer may be provided per group in some embodiments. In some embodiments, different timers may be provided for different groups.

After a successful random access procedure, the UE creates a RA resource selection report. The UE reports the communication device type that UE's access is initiated from, and the slice for which the RA access attempt was initiated (this may be relevant for multi-slice UEs). This communication device type provides information about the communication device and may be that the UE is a 5G UE, a legacy UE, an IoT device and/or any other suitable type.

The UE sends the RA resource selection report to the base station. This may be in a MSG5 message of a successful RA attempt or in any other suitable message.

The base station combines the RA resource selection reports from multiple UEs or otherwise collates the information received from different UEs.

The base station may determine the UE types that caused interference to each other and/or the slices where problems have occurred. The base station may compile a RA grouping problem report and sends it to AMF.

Using the RA grouping problem report, the AMF may change the groups.

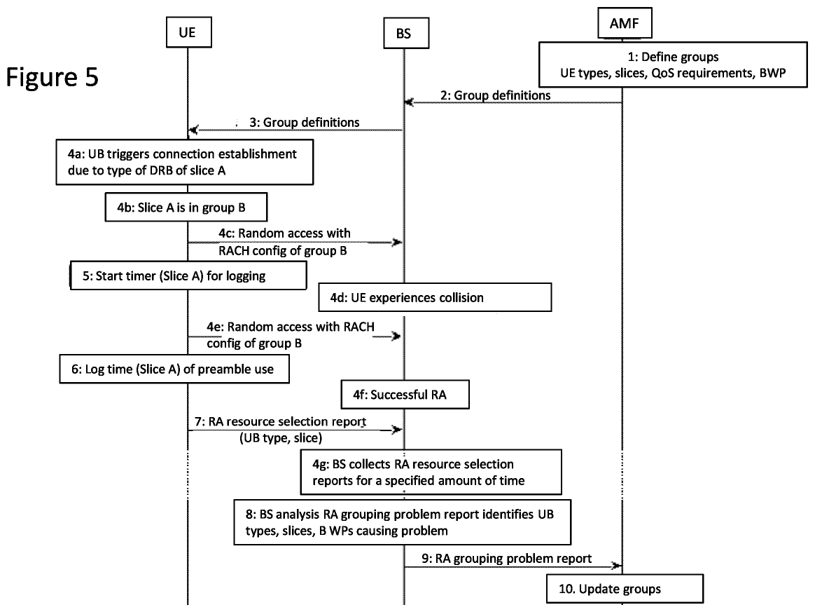

In this regard, reference is made to FIG. 5 which shows a message sequence flow of some embodiments.

In step 1, the AMF defines one or more groups. Generally the AMF will define more than one group. In the following example, the AMF defines different groups based on different slices. and/or BWPs, and/or QoS flow priorities and/or devices types (e.g. IoT device). This may use one or more of the following slice identifiers-slice indexes, S-NSSAI-s, SSTs,

Alternatively or additionally, grouping can be based on SLAs obtained from a management plane.

Alternatively, grouping may be defined as mapping table. For example, Group A=IoT devices, Group B=slice ids, Group C=Access category X. The mapping table can represent another indexed grouping, Group 1=IoT devices, Group 2=slice ids, Group 3=Access category X

In step 2, the AMF signals each group to the base station. The AMF thus provides the group definitions to the BS.

In step 3, the BS broadcasts the definition for each group and the related RACH configuration for each group. The RACH configuration may split into groups, which get different allocation for RA resources use. For example a group may be provided with one or more of a preamble group, a root sequence index, and a RA occasion to use.

In step 4a, the UE triggers a connection establishment, upon acquisition of PRACH configuration, with respect to the group.

In step 4b, the UE determines the group with respect to the slice initiating the connection. In this example, the slice is slice A and the UE determines that slice A is in in group B.

In step 4c, the UE attempts a first random access attempt on group specific resource for Group B.

In step 5 UE initiates the random access logging timer on the first RACH attempt. This is described in more detail later.

In step 4d, the first random access attempt fails due to collision.

In step 4e, the UE is configured to make a second random access attempt on group specific resource for Group B.

In step 6, the UE logs this further attempt with respect to this slice type.

In step 4f, the second random access attempt is determined to be successful.

In step 7, the UE sends a RA resource selection report to the base station. This may have the UE type and the slice.

Alternatively, the UE may add the RA resource selection report to the RA report. In this case, the UE may indicate the RA report availability in a following RRC complete message. The availability indicator may trigger a network query, upon which the UE sends the report in a UE information response message. This mechanism may alternatively be used where there is a separate RA resource selection report.

In step 8, the BS compiles a RA grouping problem report. The BS may merge the RA resource use report from a number of different UEs to compile the RA grouping report. Each RA resource use report has the information on which preamble is used by that UE and their UE types, slices, and/or the like.

The BS can detect if UE type 1 caused collision with UE type 2 in order to separate these UEs in different groups. This is assuming that these UEs may have some synchronous activity. One example may be that two slices have correlated traffic. For instance, a fire alarm in slice 1, may be sharing the resources with fire department communication in slice 2. The network is unaware of the use-case of these slices. A fire sensor will trigger fire department communication and cause the two slices to use RACH resources at the same time. This will cause a cause collision and delay to each other. As such this correlation should to be detected and separated.

The RA grouping problem report may comprise one or more of:
statistics of collision experienced between two UE types, slices, UE capabilities, and BWPs;
request for the separation of two different UE types, slices, UE capabilities, and BWPS;
the base station may suggest another grouping of UE types, slices, UE capabilities, and BWPS.

In step 9, the BS signals the RA grouping problem report to the AMF.

In step 10, the AMF updates the UE grouping using the information provided by the RA grouping problem report. The AMF may re-configure the groups for the UEs. The AMF may re-configure groups for the base stations. The AMF may aim to minimize the RA problems while doing the grouping. The updated group information is distributed as previously described.

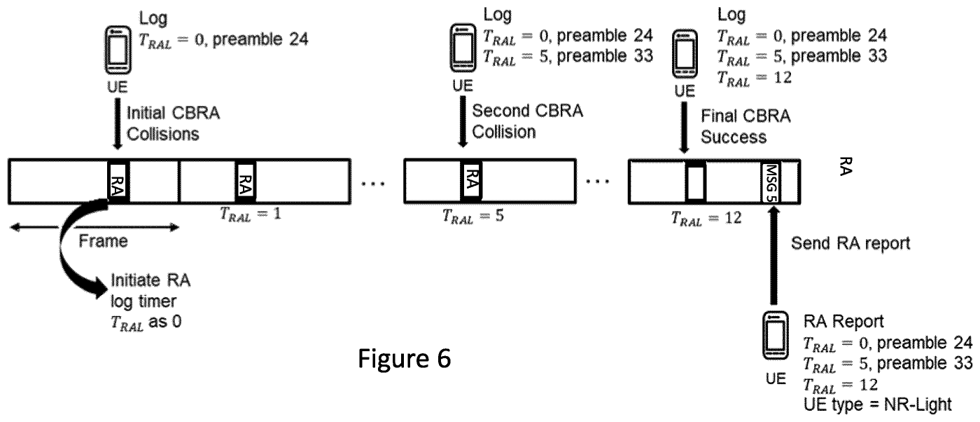

Reference is made to FIG. 6 which schematically illustrates the use of the random access log timer by the UE for RA root cause analysis.

Initially, the UE initiates the random access log (RAL) timer after an initial random access attempt. T_{RAL} is the time at which a random access attempt is made. The first random access attempt is at T_{RAL}=zero. In the example preamble 24 is selected for the initial random access attempt. The first attempt fails due to a collision.

As shown in FIG. 6, the RAL timer is incremented by one after end of each frame.

A second attempt is made at T_{RAL}=5, that is five frames after the initial attempt. This attempt also results in a failure. In this attempt, preamble 33 is selected for the second random access attempt.

A third attempt is made at T_{RAL}=12, that is 12 frames after the initial attempt. This attempt is successful.

The UE logs the values from the timer after each failed random access attempt with the ID of the preamble selected for that attempt.

In some embodiments, the UE logs only the timer value for the successful random access attempt and not the preamble. In other embodiments, the preamble may be provided for a successful random access attempt. A random access attempts is considered successful if UE can successfully receive MSG4.

The timer is stopped and reset, for example to “0” after a successful random access attempt.

If the UE initiates a new random access in a new cell, that cell can be asynchronous to the current cell and the timer may be misaligned for that cell. Accordingly, the UE re-starts the timer aligned with the broadcast of the new cell.

After the successful random access attempt, the UE may send the UE type in the RA report in the MSG5 following the MSG4.

Alternatively the UE adds the RA resource selection information to the RA report. The UE indicates the RA report availability in the following RRC (radio resource control) complete message and report along UE information response message

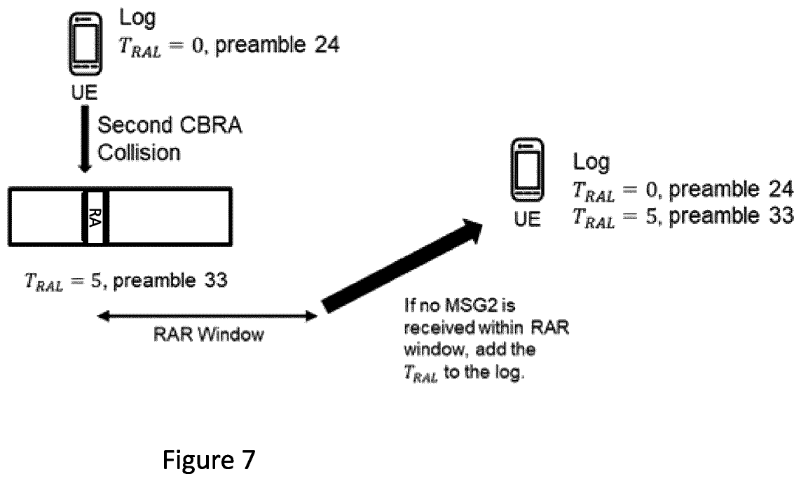

Reference is made to FIG. 7 which schematically shows of when the UE decides to append the log with the counter for a first option. When no MSG2 (or similar message) is received within the RAR (random access response) window started after the preamble transmission, the time of the preamble transmission and the preamble index may be added to the log.

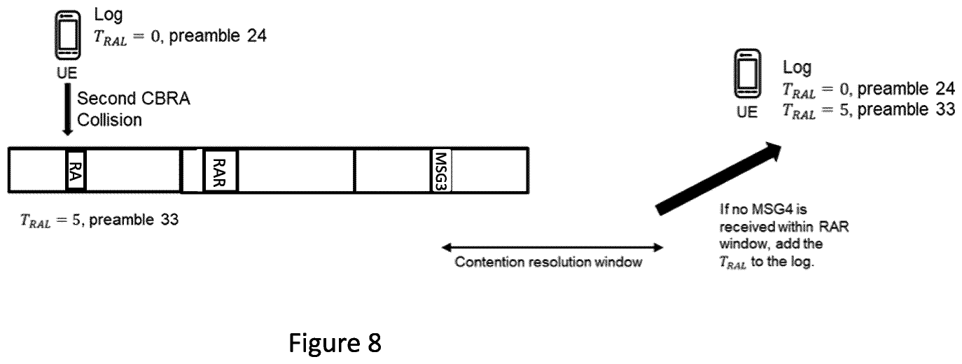

Reference is made to FIG. 8 which schematically shows of when the UE decides to append the log with the counter for a second option. When no MSG4 (or similar message) is received within the contention resolution window started after the MSG3 transmission, the time of the preamble transmission and the preamble index may be added to the log. This may be added when the contention resolution window expires without MSG4 reception.

Some embodiments may enable a re-organization of a group of different communication device types to use the same RA resource with minimal impact on each other.

It should be appreciated that if a random access attempt completely fails, the information about the random access failures are stored at the communication device and are sent the next time there is a successful random access attempt even if that attempt is associated with a different group. A random access attempt may be considered to have completely failed if n random access attempts have been made and all n attempts have failed. The value of n may be 1 or more, for example 2 or more.

In some embodiments, the information about random access failure attempts which is sent to the base station may be associated with one or more groups.

In some embodiments, the information about random access failure attempts which is sent to the base station may be associated with two or more groups.

In some embodiments, the information about random access failure attempts which is sent to the base station may be associated with one or more slices.

In some embodiments, the information about random access failure attempts which is sent to the base station may be associated with two of more different slices.

In some embodiments, the group related information may be provided by the AMF to the UEs via the N1 interface (the interface between the UE and the AMF) in 5G using NAS (non-access stratum) messaging.

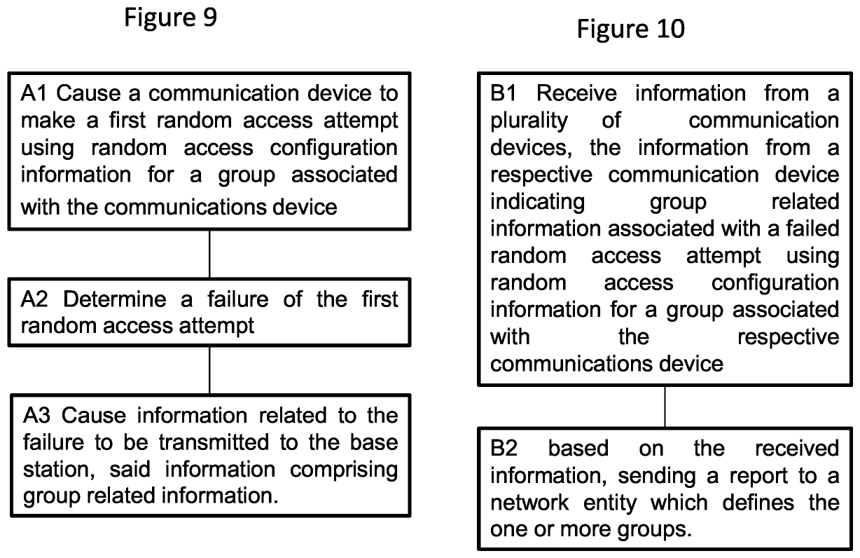

Reference is made to FIG. 9 which shows a method. The method may be performed by an apparatus. This apparatus may be as described in relation to FIG. 2 or FIG. 3. The apparatus may be provided by or in a communications device.

The method comprises in A1 causing a communication device to make a first random access attempt using random access configuration information for a group associated with the communications device.

The method comprises in A2 determining a failure of the first random access attempt.

The method comprises in A3 causing information related to the failure to be transmitted to the base station, said information comprising group related information.

Reference is made to FIG. 10 which shows a method. The method may be performed by an apparatus. This apparatus may be as described in relation to FIG. 2. The apparatus may be provided by or in a base station or other access node.

The method comprises in B1 receiving information from a plurality of communication devices, the information from a respective communication device indicating group related information associated with a failed random access attempt using random access configuration information for a group associated with the respective communications device.

The method comprises in B2, based on the received information, sending a report to a network entity which defines the one or more groups.

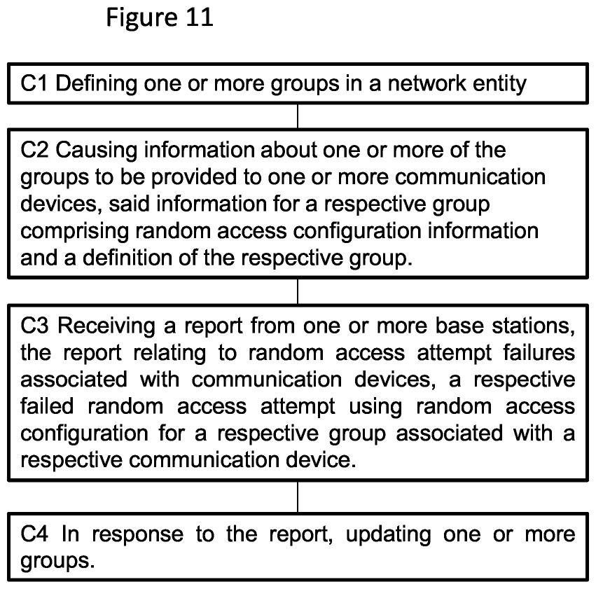

Reference is made to FIG. 11 which shows a method. The method may be performed by an apparatus. This apparatus may be as described in relation to FIG. 2. The apparatus may be provided by or in a network entity. The network entity may be an AMF . . . .

The method comprises in C1 defining one or more groups in a network entity.

The method comprises in C2; causing information about one or of the groups to be provided to one or more communication devices, said information for a respective group comprising random access configuration information and a definition of the respective group.

The method comprises in C3 receiving a report from one or more base stations, the report relating to random access attempt failures associated with communication devices, a respective failed random access attempt using random access configuration for a respective group associated with a respective communication device.

The method comprises in C4, in response to the report, updating one or more groups.

It is noted that whilst embodiments have been described in relation to 5G, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various example embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Example embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more embodiments with any of the other embodiments previously discussed.

1-24. (canceled)

25. An apparatus, comprising:
at least one processor; and
at least one memory including computer program code;
the at least one memory and the computer program code configured to, with the at least one processor, cause the apparatus at least to:
receive information of group definition and random access configuration for each group;
determine a group based on the information of group definition;
make a first random access attempt using a random access configuration for the determined group;
determine whether the first random access attempt is successful; and
transmit a random access report when the first random access attempt is successful.

26. The apparatus as claimed in claim 25, wherein the information of group definition comprises at least one of: slice information; a type of the apparatus; one or more capabilities of the apparatus; quality of service priority; one or more bandwidth parts; and information identifying the group.

27. The apparatus as claimed in claim 25, wherein determining the group based on the information of group definition comprises determining the group based on slice information initiating a connection.

28. The apparatus as claimed in claim 25, wherein resources allocated by random access configuration are different for each group.

29. The apparatus as claimed in claim 25, wherein the apparatus is further caused to:
select a random access occasion based on random access configuration for the group, and
transmit the first random access attempt in the random access occasion.

30. The apparatus as claimed in claim 25, wherein the apparatus is further caused to:
start a random access logging timer upon the first random access attempt, and
stop the random access logging timer after a successful random access attempt or a new random access in a new cell is initiated by the apparatus.

31. The apparatus as claimed in claim 30, wherein the apparatus is further caused to:
log a timer value after each failed random access attempt.

32. The apparatus as claimed in claim 31, wherein logging the timer value comprises logging the timer value with a preamble selected for that attempt.

33. The apparatus as claimed in claim 31, wherein logging the timer value comprises at least one of:
logging the timer value when a second message (MSG2) is not received by the apparatus within a random access response window, or
logging the timer value when a fourth message (MSG4) is not received by the apparatus within a contention resolution window after transmission of a third message (MSG3).

34. The apparatus as claimed in claim 31, wherein logging the timer value comprises logging the timer value with respect to a slice type.

35. The apparatus as claimed in claim 31, wherein the random access report comprises the logged timer values.

36. The apparatus as claimed in claim 30, wherein the apparatus is further caused to:
log a timer value for a successful random access attempt.

37. The apparatus as claimed in claim 25, wherein the random access report comprises a type of the apparatus.

38. An apparatus, comprising:
at least one processor; and
at least one memory including computer program code;
the at least one memory and the computer program code configured to, with the at least one processor, cause the apparatus at least to:
transmit information of group definition and random access configuration for each group, to enable a user equipment to determine a group based on the information of group definition;
receive a first random access attempt with a random access configuration for the determined group; and
receive a random access report when the first random access attempt is successful.

39. The apparatus as claimed in claim 38, wherein the information of group definition comprises at least one of: slice information; a type of the apparatus; one or more capabilities of the apparatus; quality of service priority; one or more bandwidth parts; and information identifying the group.

40. The apparatus as claimed in claim 38, wherein the apparatus is further caused to:
compile a random access grouping report based on random access reports received from a plurality of user equipment, and
send the random access grouping report to a network entity.

41. The apparatus as claimed in claim 40, wherein compiling the random access grouping report comprises determining collision information.

42. The apparatus as claimed in claim 41, wherein the collision information relates to at least one of:
collisions experienced one or more of at least two different types of user equipment, at least two different user equipment with different capabilities; different slices; and different bandwidth parts.

43. The apparatus as claimed in claim 40, wherein the random access grouping report comprises information for requesting the separation into different groups of one or more of:
two different user equipment types, two different slices; two different user equipment capabilities; and two different bandwidth parts.

44. An apparatus, comprising:
at least one processor; and
at least one memory including computer program code;
the at least one memory and the computer program code configured to, with the at least one processor, cause the apparatus at least to:
define one or more groups;
cause information about the one or more groups to be provided to one or more user equipment, said information for a respective group comprising random access configuration information and a definition of the respective group;
receiving a report from one or more base stations, the report relating to random access attempt associated with the one or more user equipment, a respective random access attempt using random access configuration for a respective group associated with a respective user equipment; and
in response to the report, updating one or more groups.
